(19) United States
(12) Patent Application Publication
(10) Pub. No.: US 2017/0038122 A1
(43) Pub. Date: Feb. 9, 2017

(54) Vehicle Refrigeration System Utilizing Individually Controllable Galley Cart Fans

(71) Applicant: B/E AEROSPACE, INC., Wellington, FL (US)

(72) Inventors: Qiao Lu, Placentia, CA (US); William J. Godecker, Irvine, CA (US)

(21) Appl. No.: 15/230,107

(22) Filed: Aug. 5, 2016

Related U.S. Application Data
(60) Provisional application No. 62/202,652, filed on Aug. 7, 2015.

(51) Int. Cl. F25D 17/06; F25D 25/00; B64D 13/08; F25D 13/02; B64D 11/04; F25D 19/00; F25D 29/00

(52) U.S. Cl. CPC F25D 17/06; F25D 19/003; F25D 25/005; F25D 29/003; F25D 13/02; B64D 11/04; B64D 13/08; F25D 2600/06; F25D 2700/12

(57) ABSTRACT

A refrigeration system for cooling a plurality of compartments includes a chiller and a duct providing fluid communication between the chiller and a plurality of compartments. The refrigeration system additionally includes a plurality of individually controllable fans that individually draw cooling fluid through the duct from the chiller and into a corresponding one of the plurality of compartments. A plurality of sensors monitors the temperature and pressure of the cooling fluid circulating through the chiller. A controller individually controls each of the plurality of individually controlled fans based on the corresponding temperature inside each of the plurality of compartments.

### CROSS REFERENCE TO RELATED APPLICATION(S)

The present application claims the priority benefit of U.S. Provisional Application No. 62/202,652, entitled “VEHICLE REFRIGERATION SYSTEM UTILIZING INDIVIDUALLY CONTROLLABLE GALLEY CART FANS,” and filed on Aug. 7, 2015, which is incorporated herein by reference in its entirety.

### BACKGROUND

Embodiments relate to refrigeration equipment. More specifically, embodiments relate to a vehicle refrigeration system utilizing individually controllable galley cart fans.

Conventional refrigeration systems for chilling food and beverages used in vehicles such as aircraft and other galley food service systems utilize a single large fan that circulates chilled air for all galley carts that receive chilled air from the refrigeration system. Thus, when any one of the galley carts needs to receive chilled air from the refrigeration system, even if none of the other galley carts do, then all of the galley carts coupled with the refrigeration system will receive the chilled air. The single fan of the refrigeration system cannot be turned off if one or more of the galley carts require cooling, even if other galley carts do not require cooling. This results in uneven cooling of the various galley carts that receive air from the refrigeration system, as well as a waste of energy expended in cooling galley carts that do not need to be cooled.

### BRIEF DESCRIPTION OF THE DRAWINGS

While the appended claims set for the features of the present techniques with particularity, these techniques may be best understood from the following detailed description taken in conjunction with the accompanying drawings of which:

FIG. 1 is a schematic diagram of an air chiller including a vapor compression cycle refrigeration system, according to an embodiment.

FIG. 2 is a graph illustrating the pressure-enthalpy chart of a refrigeration process, according to an embodiment.

FIG. 3 is a rear view of an active refrigeration system including a point of use air chiller in fluid communication with six insulated galley carts, according to an embodiment.

FIG. 4 is a side view of a galley cart in fluid communication with the active refrigeration system including a point of use air chiller as shown in FIG. 3, according to an embodiment.

FIG. 5 is a block diagram of a controller for an air chiller or vapor cycle refrigeration system, according to an embodiment.

FIG. 6 is an estimation of galley ducting heat gain according to an embodiment.

FIG. 7 is a table illustrating the performance of the air chiller, according to a first embodiment.

FIG. 8 is a table illustrating the performance of the air chiller, according to a second embodiment.

### DETAILED DESCRIPTION

While the following embodiments are described with reference to refrigeration equipment for cooling compartments in an aircraft galley, this should not be construed as limiting. Embodiments may also be used for cooling compartments in other vehicles such as ships, buses, trucks, automobiles, trains, recreational vehicles, and spacecraft, or in terrestrial settings such as offices, stores, homes, cabins, etc. Embodiments may also include refrigerator compartments.

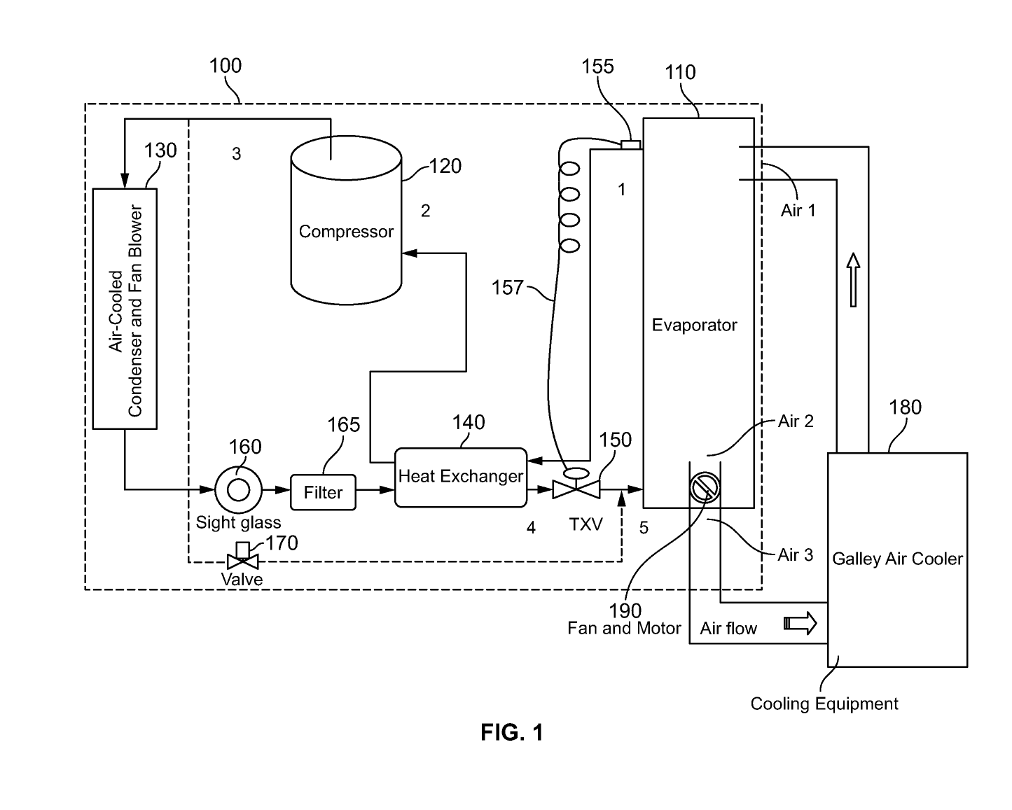

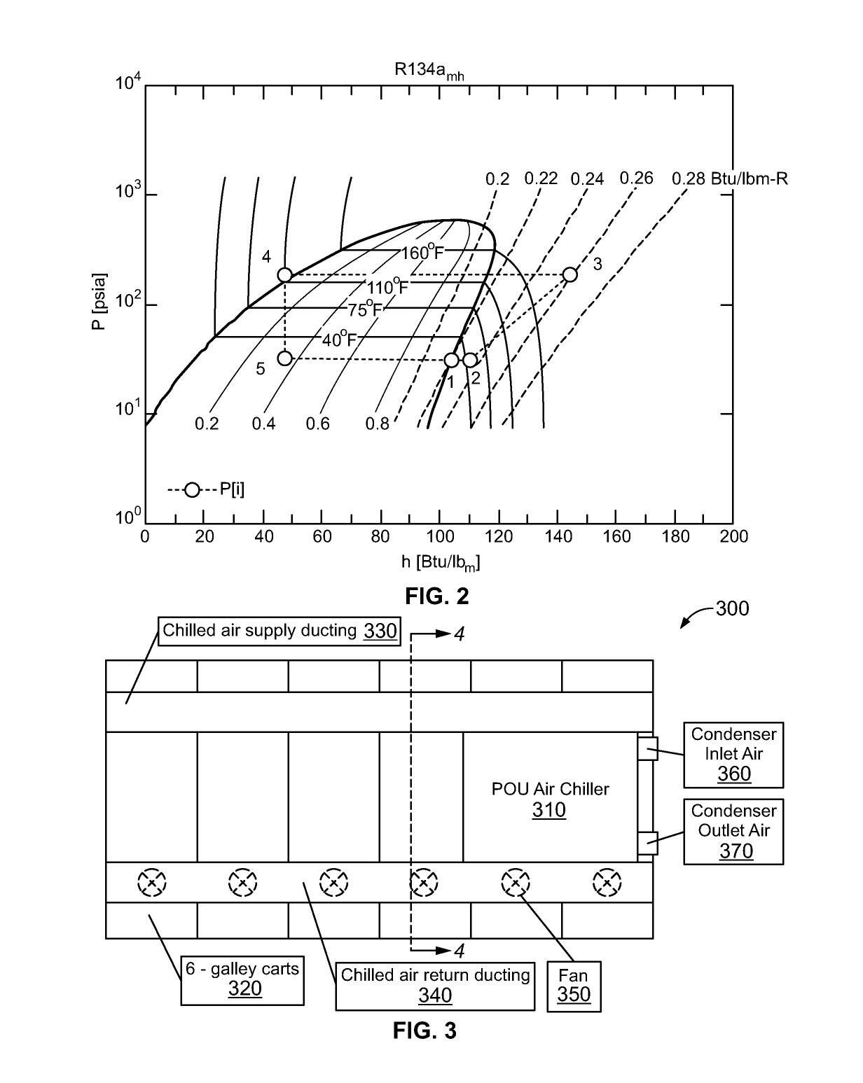

FIG. 1 is a schematic diagram of an air chiller 100 including a vapor compression cycle refrigeration system, according to an embodiment. FIG. 2 is a graph illustrating the pressure-enthalpy chart of a refrigeration process, according to an embodiment. The vapor cycle system of the air chiller 100 includes a refrigerant circulation loop that includes an evaporator 110, a compressor 120, an air-cooled condenser and fan blower 130, a refrigerant heat exchanger 140, and a thermal expansion valve (TXV) 150. In addition, the air chiller 100 includes a sight glass 160 and a refrigerant filter 165 in the refrigerant circulation loop between the air-cooled condenser and fan blower 130 and the expansion valve 150, and a valve 170 that provides a bypass for refrigerant between the output of the compressor 120 and the input to the evaporator 150.

The compressor 120, condenser 130, sight glass 160, filter 165, refrigerant heat exchanger 140, expansion valve 150, and evaporator 110 are connected by refrigerant tubing that contains refrigerant and facilitates the refrigerant moving between the vapor cycle system components over the course of the refrigeration cycle. The refrigerant is preferably one of R-134a, R404A, R236fa, and R1234yf, but may be any suitable refrigerant for a vapor cycle system known or developed in the art.

In the air chiller 100, gaseous refrigerant is output from the evaporator 110 after being evaporated by warm Air 1 provided by a piece of cooling equipment 180, for example, a galley air cooler. The cooling equipment 180 may include a plurality of galley carts and/or storage compartments for cooling food and/or beverages. Refrigerant at this stage of the cycle (stage 1) is shown at stage 1 on the Pressure-Enthalpy chart of FIG. 2 at a little above 100 Btu/lbₘ and between 10 and 100 psia. As shown in FIG. 2, at stage 1 the refrigerant is somewhat cooler than 40° F., and stage 1 crosses the 0.22 Btu/lbₘ-R line. The refrigerant then passes through the refrigerant heat exchanger 140 (discussed below) and reaches stage 2 of the cycle just prior to being compressed by the compressor 120. As shown in FIG. 2, at stage 2 the refrigerant is also somewhat cooler than 40° F., and is close to but below the 0.24 Btu/lbₘ-R line. The compressor 120 may compress refrigerant from a low-temperature, low-pressure vapor state into a high-temperature, high-pressure vapor at stage 3 of the cycle. Stage 3 nearly crosses the 0.26 Btu/lbₘ-R line shown in FIG. 2, where the temperature of the refrigerant is a little over 110° F. As refrigerant in vapor form is compressed in the compressor 120, the temperature and pressure of the refrigerant rise significantly such that the refrigerant may condense at ambient temperatures. Upon exiting the compressor 120, the refrigerant, in superheated vapor form, moves through the refrigerant tubing toward the air-cooled condenser 130. Within the condenser 130, heat from the refrigerant is rejected into air that is circulated through a heat exchanger of the condenser 130 by a fan blower. The condenser 130 condenses the refrigerant into a high pressure saturated liquid.

The condenser 130 outputs the high pressure saturated liquid refrigerant to refrigerant tubing, which then passes through a sight glass 160 and a filter 165. The filter 165 may remove any moisture and solid contaminants from the refrigerant. The filtered high pressure saturated liquid refrigerant then passes through a refrigerant heat exchanger 140 which performs sub-cooling on the refrigerant in which heat is exchanged between the refrigerant liquid passing from the condenser 130 to the expansion valve 150 and the refrigerant vapor passing from the evaporator 110 to the compressor 120. In particular, the refrigerant heat exchanger 140 performs a refrigerant liquid sub-cooling and refrigerant vapor superheating process by which the refrigerant passing from the filter 165 to the expansion valve 150 via the refrigerant heat exchanger 140 transfers heat to the refrigerant passing from the evaporator 110 to the compressor 120. By superheating the refrigerant before entering the compressor 120, droplets may be prevented from entering the compressor 120.

After being supercooled by the refrigerant heat exchanger 140, the refrigerant originating from the condenser 130 reaches stage 4 of the cycle. As shown in FIG. 2, at stage 4, the refrigerant is still a little warmer than 110° F. and is at a little above 100 psia pressure and between 40 and 50 Btu/lbₘ enthalpy. The pressure of the refrigerant at stage 4 is about the same as the pressure at stage 3, although the enthalpy is significantly lower.

After stage 4, the refrigerant originating from the condenser 130 passes through the expansion valve 150. The expansion valve 150 drops the pressure of the refrigerant to a pressure corresponding to a user-selected operating state and temperature set-point of the air chiller 100. The expansion valve 150 also causes a sudden decrease in pressure of the liquid refrigerant, thereby causing flash evaporation of a portion of the liquid refrigerant. The expansion valve 150 may include, for example, a block-type expansion valve with an internal sensing bulb. The expansion valve 150 may also be coupled with a thermal expansion remote bulb 155. The remote bulb 155 may be coupled with the expansion valve 150 by a capillary tube 157 that communicates a working gas between the expansion valve 150 and the remote bulb 155 for sensing a temperature of the refrigerant leaving the evaporator 110. Thus, the expansion valve 150 may serve as a thermostatic expansion valve and operate to control a flow of refrigerant into the evaporator 110 according to the temperature of the refrigerant leaving the evaporator 110. After the cold liquid/vapor mixture exits the expansion valve 150 and before it enters the evaporator 110, the refrigerant reaches stage 5 of the cycle. As shown in FIG. 2, the pressure of the refrigerant is about the same at stage 5 as it was at stages 1 and 2, between 10 and 100 psia. The enthalpy, however, is about the same at stage 5 as it was at stage 4, between 40 and 50 Btu/lbₘ. After stage 5, the refrigerant enters the evaporator 110 to continue the cycle.

As the low temperature and low pressure refrigerant moves through the evaporator 110, the refrigerant absorbs heat from the evaporator and lowers the temperature of evaporator fins of the evaporator 110 which then cool the air (Air 1) that circulates past the fins due to the operation of an evaporator fan and motor 190. The cooled air (Air 2) circulated by the evaporator fan and motor 190 becomes the supply chilled air (Air 3) that chills the cooling equipment, e.g., galley air cooler 180, that may cause the Air 3 to flow through a galley cart stowage area and/or galley carts. Warmed air may exit the interior of the galley cart stowage area and/or galley carts as return air (Air 1) and the evaporator fan and motor 190 then circulates the return air (Air 1) through the evaporator fins of the evaporator 110 to be cooled and once again become supply chilled air (Air 3).

The transfer of thermal energy between the return air (Air 1) circulating past the evaporator fins and the refrigerant flowing within the evaporator 110 converts the liquid refrigerant to vapor, which is then compressed by the compressor 120 as the vapor cycle system continues operation.

When the warm return air (Air 1) passes over the cold surface of the evaporator 110, moisture in the air condenses on the evaporator fins in the form of condensate. This condensate may be drained from the air chiller 100 by a condensate drain and discarded.

When the air chiller 100 is placed in a defrost mode, a hot gas defrost valve 170 may be controlled to selectively route at least a portion of the hot vapor refrigerant directly from the output of the compressor 120 into an inlet of the evaporator 110 at the refrigerant tubing in order to defrost the evaporator fins of the evaporator 110. The hot gas defrost valve 170 may include a solenoid-controlled valve.

The air chiller 110 may include a plurality of motors, sensors, and valve actuators in communication with a controller. Motors and associated electrical current sensors may include a fan motor that turns the evaporator fan (190), a fan current sensor that measures an electrical current of the fan motor for the evaporator fan, a compressor motor that drives the compressor 120, a compressor current sensor that measures an electrical current of the compressor motor that drives the compressor 120, an actuator to operate the expansion valve 150, and an actuator to operate the valve 170.

Temperature sensors may include sensors that monitor temperatures of airflow through the air chiller 100 in various locations. The temperature sensors may include a thermistor, a thermocouple, or any suitable device known in the art for measuring and reporting temperature. The temperature sensors of the air chiller 100 may include, but are not limited to, a supply air temperature sensor that measures a temperature of the supply chilled air (Air 3), and a return air temperature sensor that measures a temperature of the return air (Air 1).

Another set of sensors may monitor temperature and/or pressures of refrigerant circulating through the air chiller 100. The pressure sensors may include a pressure transducer, a pressure switch, or any suitable device known in the art for sensing fluid pressure. The pressure sensors of the air chiller 100 may include a low side pressure switch and a low side pressure transducer that sense pressure of the refrigerant at an input to the compressor 120, a high side pressure transducer that senses pressure of the refrigerant at an output of the compressor 120, and a high side pressure switch that senses pressure of the refrigerant at an output of the condenser 130. In an embodiment, the low side pressure switch may turn off the air chiller 100 when the low side refrigerant pressure is below 10 psig, and the high side pressure switch may turn off the air chiller 100 when the high side refrigerant pressure is above 325 psig.

While the embodiments shown include a vapor cycle system in the air chiller 100, this should not be construed as limiting. In various other embodiments, the air chiller 100 may include a liquid heat exchanger that cools the Air 1 using a liquid coolant circulating from a central liquid cooling system of a vehicle rather than the evaporator 110 of the illustrated vapor cycle system. In still other embodiments, a vapor cycle system and a liquid cooling system may be used together to cool the Air 1. Additionally, one or more thermoelectric devices may also be used in conjunction with any combination of the vapor cycle system and the liquid cooling system. In some alternative embodiments, the air chiller 100 may also include a liquid heat rejection system by which heat transferred from the Air 1 into the circulating refrigerant is rejected through a liquid-cooled condenser (in place of condenser 130) into liquid coolant circulating through a liquid coolant system onboard the vehicle. The circulating liquid coolant of the liquid cooling system may not be compressed by a compressor as part of a vapor cycle system, but may remain in a liquid phase throughout its circulation through the vehicle.

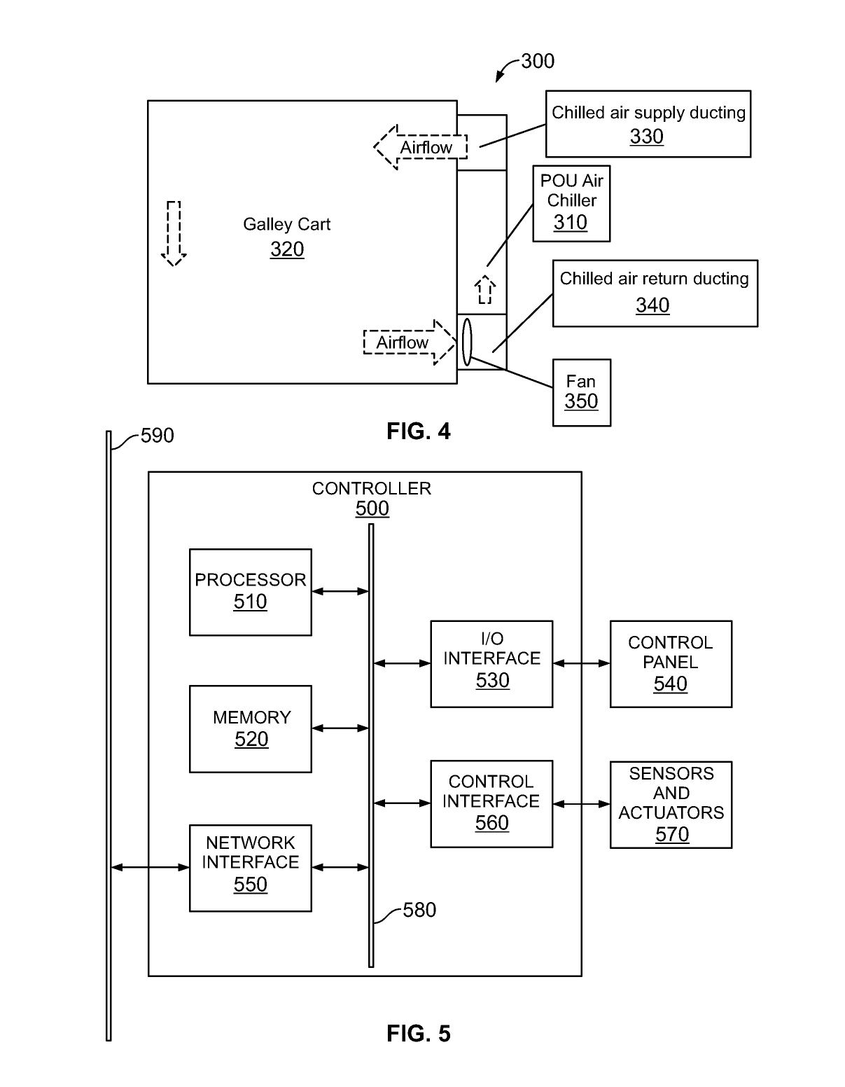

FIG. 3 is a rear view of an active refrigeration system 300 including a point of use (POU) air chiller 310 in fluid communication with six insulated galley carts 320, according to an embodiment. FIG. 4 is a side view of a galley cart 320 in fluid communication with the active refrigeration system 300 including a point of use air chiller 310 as shown in FIG. 3, according to an embodiment. FIG. 4 is shown as the cross section of the rear view at A-A on FIG. 3. The POU air chiller 310 may be an embodiment of the air chiller 100 discussed previously. The POU air chiller 310 may receive air to cool its condenser via condenser inlet air 360, and may output warmed air after cooling the condenser via condenser outlet air 370. The POU air chiller 310 may output chilled air into chilled air supply ducting 330 which routes the chilled air to each of the six insulated galley carts 320, such that each of the six insulated galley carts 320 may receive the chilled air from the chilled air supply ducting 330 in parallel with one another. The POU air chiller 310 may receive return air from the six insulated galley carts 320 via chilled air return ducting 340 which routes the warmed return air from each of the six insulated galley carts 320, such that each of the six insulated galley carts 320 may provide the return air to the chilled air return ducting 340 in parallel with one another.

Note that while insulated carts are illustrated, in various other embodiments, the carts may not be insulated. By being insulated, the carts 320 may hold their cooled temperature better, and therefore be more efficient at cooling any food or beverages that may be stored within the carts 320.

To provide an ability for the temperature of each of the insulated galley carts 320 to be better controlled and for the temperatures of all of the insulated galley carts 320 to be more uniform with each other, each of the insulated galley carts 320 includes and/or is in fluid communication with an individually controlled fan 350 that exhausts air from the insulated cart 320 into the chilled air return ducting 340. This is also illustrated in FIG. 4. The POU air chiller 310 may operate continuously, or only when at least one of the galley carts 320 needs to be chilled. While the POU air chiller 310 is operating and providing chilled air through the chilled air supply ducting 330, the fan 350 of an individual galley cart 320 may be controlled to be on or off, or proportionally controlled to move a little air or a large quantity of air by changing its speed, according to a temperature inside the individual galley cart 320. When the fan 350 runs, airflow from the chilled air supply ducting 330 flows into the individual galley cart 320 and warmed airflow flows through the fan 350 into the chilled air return ducting 340. When the fan 350 does not run, there may be minimal or no airflow from the chilled air supply ducting 330 into the individual galley cart 320, and minimal or no airflow from the interior of the individual galley cart 320 through the fan 350 into the chilled air return ducting 340. Because an opening may still be present between the galley cart 320 and each of the chilled air supply ducting 330 and the chilled air return ducting 340 when the fan 350 does not run, a small amount of airflow via convection or a reduced amount of airflow via forced airflow from the air chiller 310 may still be present, but not as significant of an amount as when the fan 350 is controlled to run. While the fan 350 is illustrated as being coupled with the chilled air return ducting 340, this should not be construed as limiting. In various embodiments, the fan 350 may instead or in addition be coupled with the chilled air supply ducting 330 to blow chilled air into the galley cart 320. Also, in various embodiments, the fan 350 may be physically installed on the chilled air return ducting 340, physically installed on the chilled air supply ducting 330, or physically installed on the galley cart 320.

Each of the fans 350 of the individual galley carts 320 may be independently controlled according to an internal temperature of its respective individual galley cart 320. During a cooling operation, when the temperature within an individual galley cart 320 reaches a preset value, the fan 350 of that individual galley cart 320 may be automatically shut off. Then, when the temperature within the individual galley cart 320 warms up to another preset value, the fan 350 of that individual galley cart 320 may be automatically turned on to cool the interior of the individual galley cart 320 again. When the fan 350 is turned on, a speed of the fan 350 may be increased or decreased proportionately according to a cooling need, which may be determined according to a sensed temperature of the individual galley cart 320 with which the fan 350 is in fluid communication and a temperature set point for the individual galley cart 320. Control of an operational status of the fan 350 may be independent of an operational status of the POU air chiller 310. Control of an operational status of the fan 350 may also be independent of an operational status of other fans 350 coupled with other galley carts 320 that also receive chilled air from the same POU air chiller 310.

The individually controlled fan 350 may be appropriately sized to provide sufficient air for just the single galley cart 320 for which the fan 350 provides chilled air. In addition, because each galley cart 320 has associated with it an individually controlled fan 350 to help the recirculation of chilled air from the POU air chiller 310 into the galley cart 320 and back again, a size and energy consumption of the output fan of the POU air chiller 310 may be reduced compared to a traditional refrigeration system in which the output fan of the air chiller is the only fan that circulates air among the galley carts.

Controlling the fan 350 of each individual galley cart 320 to run, not run, or to have a specified fan speed independently from the other individual galley carts 320 in fluid communication with a same POU air chiller 310 provides a number of benefits. The fan 350 helps the recirculation of air through the individual galley cart 320 better than a single fan at the POU air chiller 310 would. In addition, the fan 350 of each individual galley cart 320 helps balance the cooling demand and air flow within each of the individual galley carts 320. Furthermore, controlling the fan 350 of each individual galley cart 320 enables saving electrical energy of a vehicle in which the refrigeration system is installed, because the fans 350 only run when their respective galley carts 320 need cooling. Because the individually controlled fan 350 may be smaller than an air chiller output fan that outputs air from an air chiller would need to be to serve all the individual galley carts coupled with it, the individually controlled fan 350 may use significantly less energy than an air chiller output fan that outputs air from an air chiller. In addition, an overall cooling demand on the POU air chiller 310 may be reduced compared to having all the galley carts 320 be chilled by receiving chilled air from the chilled air supply ducting 330 all the time that the POU air chiller 310 operates.

FIG. 5 is a block diagram of a controller 500 for an air chiller or vapor cycle refrigeration system, according to an embodiment. The controller 500 may be coupled with the air chiller 100 or 310. The controller 500 may be coupled with a control panel 540 via an I/O interface 530. The controller 500 may receive input commands from a user via input devices, such as turning the refrigeration system on or off, selecting an operation mode, and setting a desired temperature. The controller 500 may output information to the user regarding an operational status (e.g., operational mode, activation of a defrost cycle, shut-off due to over-temperature conditions of a refrigerated compartment and/or components of the air chiller 100 or 310, etc.) of the refrigeration system using a display panel. The controller 500 may be coupled with the input devices and the display panel using shielded and twisted cables, and may communicate with the input devices and/or the display panel using an RS-232 communication protocol due to its electrically robust characteristics. Similar display panels and input devices may also be present in embodiments of refrigeration equipment, air chillers, and refrigerators with which the controller 500 may be coupled. Alternatively, similar display panels and input devices may be installed remotely from embodiments of the refrigeration equipment, air chillers, and refrigerators with which the controller 500 may be coupled.

The controller 500 may include a processor 510 that performs computations according to program instructions, a memory 520 that stores the computing instructions and other data used or generated by the processor 510, and a network interface 550 that includes data communications circuitry for interfacing to a data communications network 590 such as Ethernet, Galley Data Bus (GAN), or Controller Area Network (CAN). The processor 510 may include a microprocessor, a Field Programmable Gate Array, an Application Specific Integrated Circuit, or a custom Very Large Scale Integrated circuit chip, or other electronic circuitry that performs a control function. The processor 510 may also include a state machine. The controller 500 may also include one or more electronic circuits and printed circuit boards. The processor 510, memory 520, and network interface 550 may be coupled with one another using one or more data buses 580. The controller 500 may communicate with and control various sensors and actuators 570 of the air chiller 100 via a control interface 560.

The controller 500 may be controlled by or communicate with a centralized computing system, such as one onboard an aircraft. The controller 500 may implement a compliant ARINC 812 logical communication interface on a compliant ARINC 810 physical interface. The controller 500 may communicate via the Galley Data Bus (e.g., galley networked GAN bus), and exchange data with a Galley Network Controller (e.g., Master GAIN Control Unit as described in the ARINC 812 specification). In accordance with the ARINC 812 specification, the controller 500 may provide network monitoring, power control, remote operation, failure monitoring, and data transfer functions. The controller 500 may implement menu definitions requests received from the Galley Network Controller (GNC) for presentation on a GNC Touchpanel display device and process associated button push events to respond appropriately. The controller 500 may provide additional communications using an RS-232 communications interface and/or an infrared data port, such as communications with a personal computer (PC) or a personal digital assistant (PDA). Such additional communications may include real-time monitoring of operations of the air chiller 100, long-term data retrieval, and control system software upgrades. In addition, the control interface 560 may include a serial peripheral interface (SPI) bus that may be used to communicate between the controller 500 and motor controllers within the air chiller 100 or 310.

The air chiller 100 or POU air chiller 310 may be configured to refrigerate beverages and/or food products which are placed in chilled or refrigerated compartments (e.g., galley carts 320) with which the air chiller 100 or POU air chiller 310 is operatively attached. The air chiller 100 or POU air chiller 310 may operate in one or more of several modes, including refrigeration, beverage chilling, and freezing. A user may select a desired temperature for a refrigerated compartment using the control panel 540. The controller 500 included with the air chiller 100 or POU air chiller 310 may control a temperature within the refrigerated compartment at a high level of precision according to the desired temperature. Therefore, quality of food stored within the refrigerated compartment may be maintained according to the user-selected operational mode of the air chiller 100 or POU air chiller 310.

In various embodiments, the air chiller 100 or POU air chiller 310 may maintain a temperature inside the refrigerated compartment according to a user-selectable option among several preprogrammed temperatures, or according to a specific user-input temperature. For example, a beverage chiller mode may maintain the temperature inside the refrigerated compartment at a user-selectable temperature of approximately 9° C., 12° C., or 16° C. In a refrigerator mode, the temperature inside the refrigerated compartment may be maintained at a user-selectable temperature of approximately 4° C. or 7° C. In a freezer mode, the temperature inside the refrigerated compartment may be maintained at a user-selectable temperature of approximately −18° C. to 0° C.

The controller 500 may poll sensors at a fixed minimum rate such that all data required to control the performance of the air chiller 100 or POU air chiller 310 may be obtained by the controller 500 in time for real-time operation of the one or more cooling systems within the air chiller 100 or POU air chiller 310. The polled values may be reported by the controller 500 via the RS-232 or infrared interface to a personal computer or PDA and may be reported over a controller area network (CAN) bus. The polled values may also be used in control algorithms by the controller 500, and may be stored to long-term memory or a data storage medium for later retrieval and analysis.

The controller 500 may provide a self-protection scheme to protect against damage to the air chiller 100 or POU air chiller 310 and its constituent components due to abnormal external and/or internal events such as over-temperature conditions, over-pressure conditions, over-current conditions, etc. and shut down the air chiller 100 or POU air chiller 310 and/or one or more of its constituent components in accordance with the abnormal event. The self-protection scheme may include monitoring critical system sensors and taking appropriate self-protection action when monitored data from the sensors indicate a problem requiring activation of a self-protection action. Such a self-protection action may prevent the air chiller 100 or POU air chiller 310 and/or its constituent components from being damaged or causing an unsafe condition. The self-protection action may also provide appropriate notification via a display panel regarding the monitored problem, the self-protection action, and/or any associated maintenance required. The controller's self-protection scheme may supplement, rather than replace, mechanical protection devices which may also be deployed within the air chiller 100 or POU air chiller 310. The controller 500 may use monitored data from the sensors to intelligently restart the air chiller 100 or POU air chiller 310 and reactivate the desired operational mode after the abnormal event which triggered the self-protection shut-down has terminated or reduced in severity.

The air chiller 100 or POU air chiller 310 may be controlled by an electronic control system associated with the controller 500. The memory 520 of the controller 500 may store a program for performing a method of controlling the air chiller 100 or POU air chiller 310 executable by the processor 510. The method of controlling the air chiller 100 or POU air chiller 310 performed by the electronic control system may include a feedback control system such that the air chiller 100 or POU air chiller 310 may automatically maintain a prescribed temperature in a food and beverage storage compartment with which the air chiller 100 or POU air chiller 310 is coupled.

The air chiller 100 or POU air chiller 310 may be a line replaceable unit (LRU) for an aircraft, and may provide refrigeration functionality while the aircraft is both on the ground and in flight. The refrigeration may be provided using a cooling system as herein. The air chiller 100 or POU air chiller 310 may be designed according to an ARINC 810 standard. The air chiller 100 or POU air chiller 310 may be configured to operate using an electrical power source such as three phase 115 or 200 volts frequency alternating current (AC) at a frequency of 360 to 900 Hz. The air chiller 100 or POU air chiller 310 may employ AC to DC power conversion to provide a predictable and consistent power source to motors and/or valve actuators. The air chiller 100 or POU air chiller 310 may also include a polyphase transformer (e.g., a 15-pulse transformer) to reduce current harmonics reflected from the air chiller 100 back into an airframe power distribution system with which the air chiller 100 or POU air chiller 310 may be coupled.

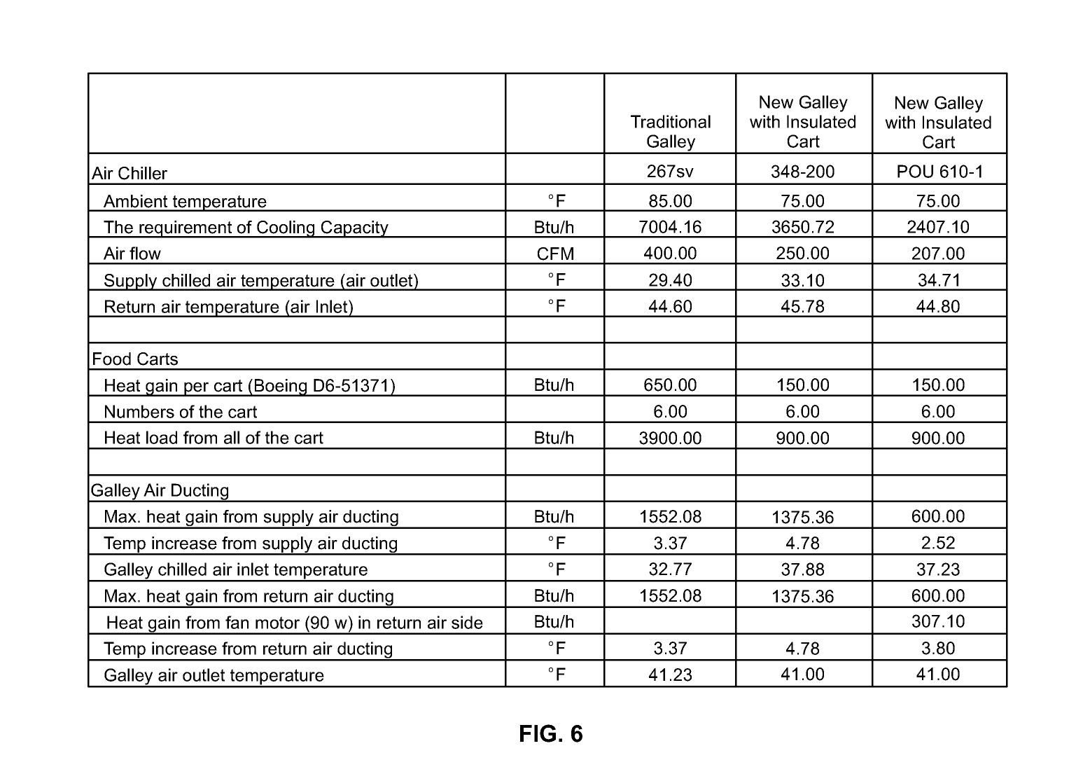

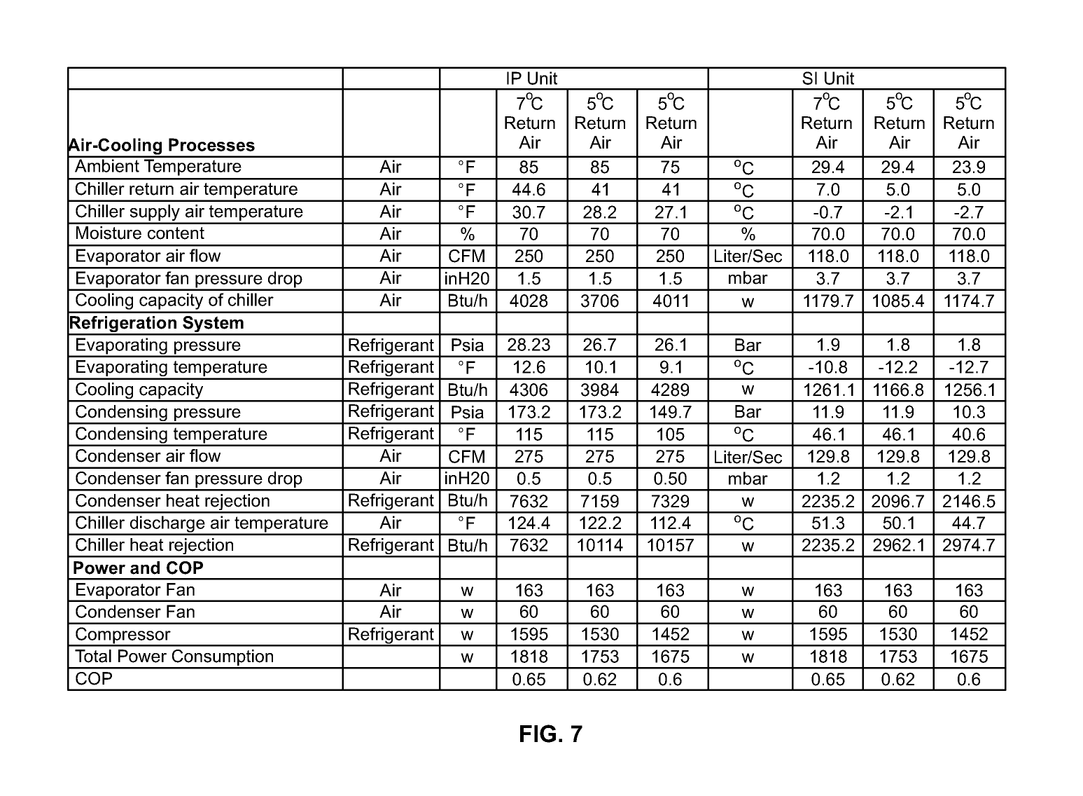

An estimation of galley ducting heat gain according to an embodiment is shown in FIG. 6.

Following are performance parameters and design specifications for a first exemplary embodiment:
Hold temperature: 41° F.
Operating ambient temperature: 75° F.
Chilled air ducting is similar to a traditional galley with 267sv air chiller
This first embodiment is based on the estimation of air ducting heat gain in FIG. 6
The performance of this first embodiment is presented in FIG. 2.
The interface details of this first embodiment is listed below:
   Length: 26.7 in. (678.7 mm)
   Width: 15.2 in. (384.8 mm)
   Height: 10.7 in. (277.3 mm)
   Operational weight: 53 lbm. (24 kg)
   Electrical connector type: MS24264R16B10PN/MS24264R16B10P6

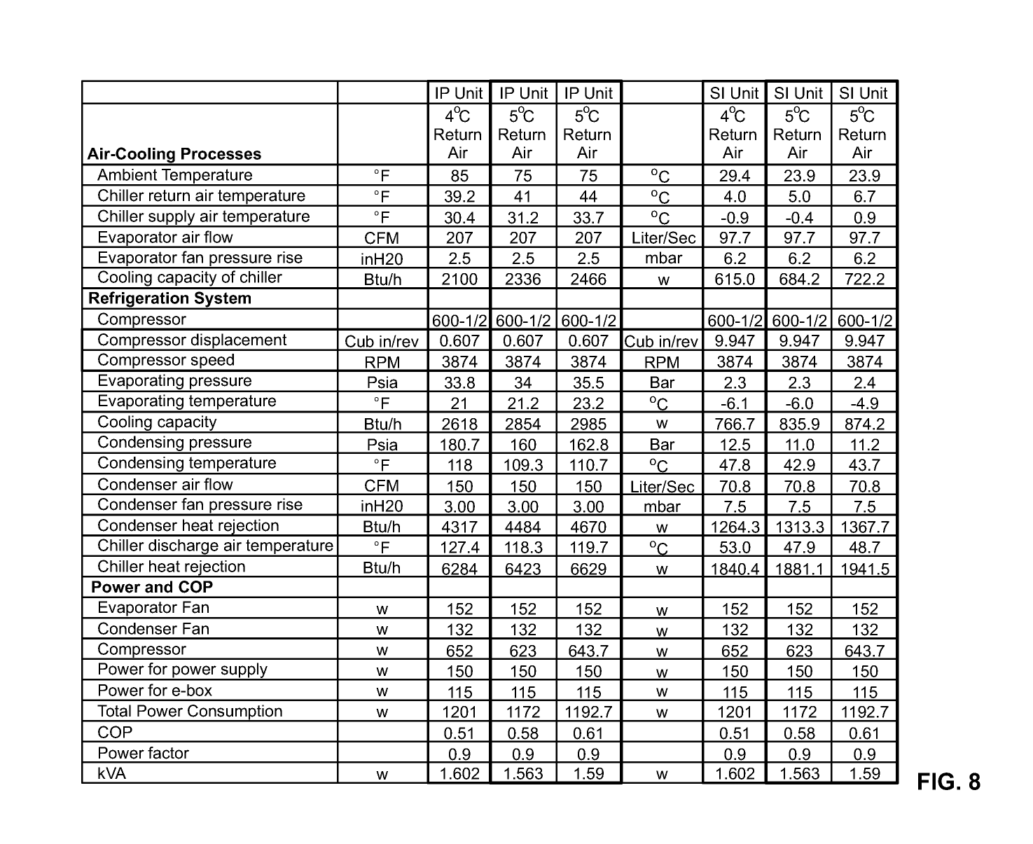

Following are performance parameters and design specifications for a second exemplary embodiment:
Hold temperature: 41° F.
Operating ambient temperature: 75° F.
New designed chilled air ducting with maximum heat gain of 1200 Btu/h.
A fan (30 CFM at 0.5 inH2O, 15 w) is installed in the air outlet of each insulated cart to help chilled air circulation.
This second embodiment is based on the estimation of air ducting heat gain in FIG. 6
The general layout of refrigeration system with insulated carts, POU chiller, chilled air ducting, and fans is shown in FIG. 3.
The performance of this second embodiment is presented in FIG. 8.
The Interface details of this second embodiment is listed below:
   Depth: 4.10 in. (104.1 mm)
   Width: 24.00 in. (609.6 mm)
   Height: 19.00 in. (482.6 mm)
   Operational weight: 45-50 lbm. (20.4-22.7 kg)
   Electrical connector type: D38999/20ME6PN.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the refrigeration system disclosed here, reference has been made to the embodiments illustrated in the drawings, and specific language has been used to describe these embodiments. However, no limitation of the scope of the disclosure is intended by this specific language, and the refrigeration system should be construed to encompass all embodiments that would normally occur to one of ordinary skill in the art. The terminology used herein is for the purpose of describing the particular embodiments and is not intended to be limiting of exemplary embodiments of the refrigeration system.

The apparatus described herein may comprise a processor, a memory for storing program data to be executed by the processor, a permanent storage such as a disk drive, a communications port for handling communications with external devices, and user interface devices, including a display, keys, etc. When software modules are involved, these software modules may be stored as program instructions or computer readable code executable by the processor on a non-transitory computer-readable media such as read-only memory (ROM), random-access memory (RAM), CD-ROMs, DVDs, magnetic tapes, hard disks, floppy disks, and optical data storage devices. The computer readable recording media may also be distributed over network coupled computer systems so that the computer readable code is stored and executed in a distributed fashion. This media may be read by the computer, stored in the memory, and executed by the processor.

Also, using the disclosure herein, programmers of ordinary skill in the art may easily implement functional programs, codes, and code segments for making and using the disclosed apparatus.

The disclosed apparatus may be described in terms of functional block components and various processing steps. Such functional blocks may be realized by any number of hardware and/or software components configured to perform the specified functions. For example, the refrigeration system may employ various integrated circuit components, e.g., memory elements, processing elements, logic elements, look-up tables, and the like, which may carry out a variety of functions under the control of one or more microprocessors or other control devices. Similarly, where the elements of the refrigeration system are implemented using software programming or software elements, the refrigeration system may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the refrigeration system may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism” and “element” are used broadly and are not limited to mechanical or physical embodiments, but may include software routines in conjunction with processors, etc.

The use of any and all examples, or exemplary language (e.g., “such as”) provided herein, is intended merely to better illuminate the disclosed refrigeration system and does not pose a limitation on the scope of the disclosure unless otherwise claimed. Numerous modifications and adaptations will be readily apparent to those of ordinary skill in this art without departing from the spirit and scope of the disclosure as defined by the following claims.

No item or component is essential to the practice of the disclosure unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the refrigeration system (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A refrigeration system for cooling a plurality of compartments comprising:
a chiller;
a duct providing fluid communication between the chiller and a plurality of compartments; and
a plurality of individually controllable fans that individually draw cooling fluid through the duct from the chiller and into a corresponding one of the plurality of compartments.

2. The refrigeration system according to claim 1, further comprising:
a plurality of sensors configured to monitor at least one of a temperature and a pressure of the cooling fluid circulating through the chiller.

3. The refrigerant system according to claim 1, wherein each of the plurality of compartments is in fluid communication with the corresponding individually controllable fan of the plurality of individually controllable fan.

4. The refrigerant system according to claim 1, further comprising:
a plurality of sensors configured to monitor the temperature inside each of the plurality of compartments; and
a controller configured to:
receive output from the plurality of sensor relating to the temperature inside each of the plurality of compartments; and
individually control each of the plurality of individually controlled fans based on the corresponding temperature inside each of the plurality of compartments.

5. The refrigerant system according to claim 4, wherein
the controller is further configured to individually control each of the individually controlled fans to be one of: i) on; ii) off; iii) to move a small amount of air; or iv) to move a large amount of air by altering a speed of each of the plurality of individually controlled fans.

6. The refrigerant system according to claim 4, wherein the controller is further configured to:
compare the temperature inside each of the plurality of compartments to predetermined value; and
control each of the plurality of individually controlled fans to maintain the temperature inside the corresponding compartment within a predetermined range.

7. The refrigeration system according to claim 1, wherein each of the plurality of individually controlled fans are sized to provide sufficient air for one compartment of the plurality of individually controlled fans.

8. The refrigeration system according to claim 4, wherein the controller is further configured to:
receive an mode selection input via a user interface; and
individually control each of the plurality of individually controlled fans based on the mode selection input.

9. The refrigeration system according to claim 8, wherein the mode selection input is selected from a menu comprising: i) a refrigeration mode; ii) a beverage chilling mode; and
iii) a freezing mode.

10. The refrigeration system according to claim 4, wherein the controller is further configured to poll the plurality of sensors at a fixed minimum rate.

11. The refrigeration system according to claim 4, wherein the controller is further configured to:
monitor a fault status of the chiller; and
control each of the plurality of individually controlled fans based on the fault status of the chiller.
